(19) United States
(12) Patent Application Publication
(10) Pub. No.: US 2009/0249970 A1
(43) Pub. Date: Oct. 8, 2009

(54) Dampening Device of a Spray-Dampening Unit

(75) Inventor: Hary Kosciesza, Borchen (DE)

Correspondence Address: RICHARD M. GOLDBERG, 25 EAST SALEM STREET, SUITE 419, HACKENSACK, NJ, 07601, US

(73) Assignee: Technotrans AG, Sassenberg (DE)

(21) Appl. No.: 12/414,213

(22) Filed: Mar. 30, 2009

(30) Foreign Application Priority Data
Apr. 4, 2008 (DE) 102008017275.8-27

(51) Int. Cl. B41L 25/00

(52) U.S. Cl. 101/147

(57) ABSTRACT

A dampening device of a spray-dampening unit includes a dampening-unit housing, with a positioning element and a spray bar, the positioning element having a mounting region and an abutment region, and being mounted exchangeably on the dampening-unit housing via the mounting region, and the abutment region configured such that the spray bar can be brought to abut against the abutment region, so that a defined position of the spray bar in relation to the dampening-unit housing can be ensured, and also to a method for positioning a spray bar in a dampening device of this type, including the steps of providing a set of positioning elements which each have a mounting region and an abutment region, the set having different positioning elements, selecting a positioning element suitable for a desired position of the spray bar in the dampening-unit housing from the set, and mounting the selected positioning elements.

### FIELD OF THE INVENTION

The invention relates to a dampening device of a spray-dampening unit for printing machines and to a method for positioning a spray bar in such a dampening device.

### BACKGROUND OF THE INVENTION AND PRIOR ART

Dampening units are used in printing technology. As a rule, in dampening units, these devices consist of a series of rollers which touch one another and which apply a dampening medium (usually water and several additives) uniformly to a printing plate.

By means of dampening units, the water can be applied via a water fountain, via nozzles or in a similar way, for example, to a duct roller and can then be conveyed as a water film over all the rollers uniformly to the printing plate. The dampening units in which nozzles are used are also designated as spray-dampening units.

Spray-dampening units have, as a rule, a spray bar which carries spray valves and which is mounted on a housing so as to be adjustable in the direction of the roller and away from the latter for different intended uses.

A spray-dampening unit of this type is known from EP 1 009 633 B1. In the known device, the two ends of a spray bar are held in such a way that the spray bar and consequently the spray nozzles can be adjusted with respect to the roller.

Patent specification DE 698 35 545 T2 describes a spray-dampening unit, the spray bar of which is fastened pivotably to a fixedly mounted spray space. The spray-dampening unit is subdivided into two components, a spray space mounted fixedly on the printing press frame and a rear pivotable bar in which the spray valves are located.

Further spray-dampening units are described in DE 198 11 554 C1 and DE 103 17 470 B4.

In the known spray-dampening units, the maintenance of the valves, the control of dirt in the spray space and cleaning of the appliance are sometimes difficult. The set-up of the spray-dampening unit is complicated and can sometimes be adapted to the prevailing conditions to only a limited extent.

### OBJECT

The object on which the invention is based is to provide a dampening device of a spray-dampening unit for printing machines which can be produced at low cost and is simple to maintain and/or retrofit and also a method for positioning a spray bar in such a dampening device.

### SOLUTION FOR ACHIEVING THE OBJECT

The object is achieved by means of the devices and the method according to the independent claims. Advantageous embodiments are disclosed in the subclaims.

A first aspect of the invention relates to a dampening device of a spray-dampening unit with a dampening-unit housing, with a spray-bar mounting and with a spray bar, the spray bar being connected to the dampening-unit housing via the spray-bar mounting in such a way that the spray bar is pivotable between an operating position and a servicing position, in the servicing position the spray bar having in relation to the spray-bar mounting at least one degree of freedom which makes it possible for the spray bar to be removable from the spray-bar mounting, and this at least one degree of freedom being taken away from the spray bar when the latter is being pivoted into the operating position.

The dampening-unit housing, which could also be designated as a spray housing, may be fastened to a machine stand of the printing machine or of the dampening unit. The dampening-unit housing may extend parallel to and along the body to be dampened. The body to be dampened may be a duct roller of the dampening unit. On the spray bar, dampening-medium spray nozzles may be provided which, in the servicing position, may be freely accessible from outside the dampening-unit housing. In the art, and also in the sense used here, the term “degree of freedom” describes the possibility of movement of bodies in space. The term is often used in connection with joints and designates the number and type of possible movements which the joint can execute. What is taken as a basis in this case is that a body possesses three rotational and three translational degrees of freedom in space. A joint arises when two bodies are connected to one another in such a way that, via the articulated relation of one body to the other, at least one of the six degrees of freedom of the other body is taken away. The degree of freedom of the spray bar in the servicing position may be a translational degree of freedom. The translational degree of freedom may be afforded to the spray bar in relation to the nozzle spraying direction in the servicing position. Without the degree of freedom or degrees of freedom in the servicing position, the spray bar can have in the operating position an attitude which is defined in relation to the dampening-unit housing and which predetermines a distance of the spray nozzles from the body to be dampened. The operating position is the position in which the spray bar is located when the spray-dampening unit is in operation. The body to be dampened may be, for example, a roller to be dampened, in particular a duct roller of the spray-dampening unit.

A further embodiment relates to such a dampening device of a spray-dampening unit in which the spray bar, together with the spray-bar mounting, is pivotable between the operating position and the servicing position.

Furthermore, in a further embodiment of such a dampening device, the spray-bar mounting may have two essentially U-shaped profiles, each with two legs, in the servicing position the spray bar being inserted into the U-shaped profiles and being held displaceably between the legs of the U-shaped profiles. In this embodiment, the spray bar may have displaceability in the direction of a longitudinal extent of the legs, that is to say in the removal direction. At least one translational degree of freedom (displaceability in the removal direction) can thus be provided. Another configuration of a longitudinal guide which provides a translational degree of freedom in the removal direction may also be envisaged. The translational degree of freedom in the removal direction may be in a direction which runs parallel to a radius emanating from the pivot axis.

Furthermore, such a dampening device may have a configuration in which the U-shaped profiles are arranged on a servicing flap in such a way that, when the servicing flap is opened, the U-shaped profiles, together with the spray bar, are pivoted out of the dampening-unit housing into the servicing position. A servicing flap defines a flap on the dampening-unit housing of a dampening device, via which flap access to the spray bar can be permitted for the purpose of its maintenance, etc. The servicing flap may extend essentially over the length of the spray bar.

Moreover, a dampening device of this type may have a configuration in which, in the operating position of the spray bar, the dampening-unit housing forms in front of the spray bar in the spraying direction an essentially closed-off spray space, the dampening-unit housing having in the region of the spray space an inspection flap, via which the spray space is accessible from outside the dampening-unit housing. In this case, the inspection flap may be arranged such that a viewing of the spray bar in the operating position can be carried out. The inspection flap makes it possible to check the spray pattern and dirt in the spray space and/or the spray nozzles. The inspection flap may extend essentially over the length of the spray bar. “Essentially closed-off” relates to the operating state of the dampening unit in which the dampening-unit housing is arranged in the immediate vicinity of the body to be dampened, so that the body to be dampened shuts off a spray port in the dampening-unit housing to the spray space on one side. The body to be dampened may be, for example, a duct roller of a dampening unit.

A further embodiment relates to a dampening device of this type in which, during the pivoting of the spray bar into the operating position, its at least one degree of freedom is taken away via the pivoting of a holding region of the spray bar into a guide orifice of a positioning element. A holding region of the spray bar may be provided via an appropriate configuration, matching with a guide-orifice cross section, of a spray-bar cross section. For example, the spray-bar cross section may have an essentially rectangular configuration, and the guide-orifice cross section may, for example, have at least one planar abutment region against which one side of the rectangular spray-bar cross section is brought to abut in the servicing position. The planar abutment region may run transversely or perpendicularly with respect to the spraying direction of the spray nozzles. By the spray bar abutting against the abutment region, the distance between the spray bar and, for example, the duct roller in the spraying direction can be predetermined.

A second aspect of the invention relates to a dampening device of a spray-dampening unit with a dampening-unit housing, with a positioning element and with a spray bar, the positioning element having a mounting region and an abutment region, the positioning element being mounted exchangeably on the dampening-unit housing via the mounting region, and the abutment region being configured in such a way that the spray bar can be brought to abut against the abutment region of the positioning element, so that a defined position of the spray bar in relation to the dampening-unit housing can be ensured via the abutment against the abutment region. The mounting region designates that region of the positioning element via which the positioning element can be mounted in the dampening-unit housing. The abutment region is a region with functional surfaces on which touch contact between the spray bar and positioning element can be provided. The abutment region may have surface regions which are adapted to the contour of the spray bar in matching surface regions. The surface regions of the abutment region may correspond to the surface configuration of the spray bar in the holding region of the latter. One or more positioning elements may be provided per spray bar for positioning the spray bar in the dampening-unit housing. A positioning element may, for example, have a plate-shaped configuration and/or be mounted on a side part of the dampening-unit housing. In the case of a plurality of positioning elements per spray bar, these may be provided, for example, on both sides of the dampening-unit housing at the ends of the spray bar. An arrangement in the middle region of the spray bar in the operating position of the latter may also be envisaged.

A dampening device of this type may have a configuration in which the dampening device has a fine-setting device, via which the exchangeable mounting of the positioning element on the dampening-unit housing can be brought about, and via which the position of the positioning element with respect to the dampening-unit housing can be finely set. A fine-setting device of this type may be obtained, for example, by a screwing of the positioning element via long holes. In this case, the long holes may be arranged, for example, in the side parts of the dampening-unit housing and/or in the respective positioning element itself.

In this case, a dampening device of this type may have a set of positioning elements in which the abutment regions are in different positions with respect to the mounting regions, so that a rough setting of the position of the spray bar in the dampening-unit housing can be carried out via the selection of the respective positioning element or positioning elements. The positioning elements may be provided, for example, as essentially plate-shaped castings, in particular injection mouldings. The positioning elements may be produced in one piece and/or from plastic.

A further embodiment relates to a dampening device of this type in which the abutment region of the positioning element is provided in the region of a guide orifice of the positioning element, into which the spray bar can be inserted into an operating position and/or can be removed from this.

Possible, furthermore, is a configuration of a dampening device of this type which has, furthermore, the features described above with regard to the first aspect of the invention.

Moreover, a dampening device of this type may have a configuration in which the guide orifice of the positioning element has an orifice region with an orifice width which is greater than the corresponding width of the spray bar, the guide orifice having a bottom region with a bottom width which conforms to the corresponding width of the spray bar. The orifice region designates that region of the positioning element through which the spray bar first passes when it is pivoted into its operating position. The bottom region designates that region of the positioning element which surrounds the spray bar on both sides when the spray bar has reached its operating position. Thus, for example, a firm clamping of the spray bar in this position can be affected via this configuration of the bottom width.

Furthermore, in one embodiment of the dampening device, the guide orifice of the positioning element may have an elastically deformable locking region which, after the complete insertion of the spray bar, fixes the spray bar in its operating position. A locking region of this type may be formed in one piece with the positioning element, for example as a latching element. A version of the locking region is also conceivable as an independent component which is mounted on the positioning element or is provided and/or mounted on the dampening device independently of the positioning element.

A third aspect of the invention relates to a method for positioning a spray bar in a dampening device of a spray-dampening unit, comprising the steps
provision of a dampening-unit housing,
provision of a set of positioning elements which each have a mounting region and an abutment region, the set having different positioning elements,
provision of a spray bar,
selection of a positioning element suitable for a desired position of the spray bar in the dampening-unit housing from the set of positioning elements,
mounting of the selected positioning elements.

In the method, the mounting of the selected positioning element may take place via the mounting region of the positioning element on matching dampening-unit mounting regions of the dampening-unit housing. The spray bar can then be brought into abutting contact with an abutment region of the positioning element. The procedure may even take place in reverse, such that the positioning element has been mounted on the spray bar and abutment regions of the selected positioning elements are brought into abutting contact with abutment regions in the dampening-unit housing. A difference between positioning elements of the set may lie in a different position of the respective abutment region in relation to the mounting region provided in each case. Thus, different positions of the spray bar can be set in a simple way with comparatively short set-up times. A difference between positioning elements of the set may lie, furthermore, in a different configuration of a guide orifice of a positioning element. Thus, via different positioning elements, different spray bars can be mounted in a simple way in the dampening-unit housing, along with the advantages mentioned.

In a method of this type, the provided dampening device of a spray-dampening unit may be a dampening device described with regard to the second aspect of the invention, and the provided set of positioning elements may also be a set of positioning elements according to the second aspect of the invention.

Individual embodiments of the invention are described by way of example below. In this case, the individual embodiments described sometimes have features which are not absolutely necessary for implementing the present invention, but which provide generally desired properties in specific applications. Thus, embodiments which do not have all the features of the embodiments described below are also to be considered as disclosed and coming under the teaching of the invention. Moreover, in order to avoid unnecessary repetition, specific features are described only in relation to individual embodiments. It is pointed out that the individual embodiments are therefore not only to be considered in themselves, but also individual embodiments may be able to be modified by the incorporation of individual or several features of other embodiments. It is pointed out that a systematic combination of the individual embodiments with individual or several features which are described in relation to other embodiments may be desirable and expedient and is therefore to be considered both as being taken into consideration and as being covered by the description.

### BRIEF DESCRIPTION OF THE DRAWINGS

In the figures:

FIG. 1 shows a preferred embodiment of a dampening device according to the invention in an isometric view,

FIG. 2 shows a side view of an embodiment of the dampening device according to the invention with a spray bar in the servicing position,

FIG. 3 shows a side view of an embodiment of the dampening device according to the invention with a spray bar in the operating position, and

FIG. 4 shows an isometric view of a positioning element of the dampening device.

### DETAILED DESCRIPTION OF THE DRAWING

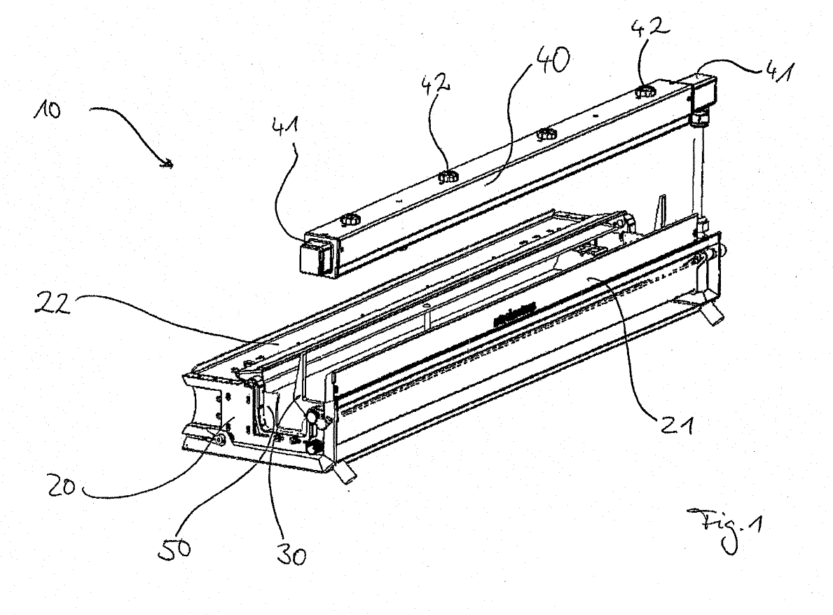

FIG. 1 shows a preferred embodiment of a dampening device 10 according to the invention in an isometric view.

The figure illustrates the dampening device 10 in a servicing position in which a spray bar 40 has been removed from a spray-bar mounting 30.

In FIG. 1 and in the other figures, it has been refrained from showing the remaining parts of a spray-dampening unit or a printing machine on which a spray-dampening unit of this type is arranged. A duct roller, which may be dampened, for example, by the dampening device 10, is therefore also not illustrated.

It is clear, however, that a dampening-unit housing 20 of the dampening device 10 has on the left-hand side in FIG. 1 a concave recess which is adapted to the convex surface profile of the duct roller, so that the dampening device 10 can be brought closely up to the duct roller.

The dampening device 10 illustrated in the servicing position has in the rear part of the dampening-unit housing 20 a servicing flap 21 which is swung up in the servicing position illustrated. Furthermore, an inspection flap 22, through which the inner region of a spray space 23 is accessible, is illustrated on the dampening-unit housing 20 in front of the spray bar 40 in the spraying direction of the latter.

A spray-bar mounting 30 is arranged on the servicing flap 21 and is designed as a fork-shaped mounting in the embodiment illustrated. The mounting may have an essentially U-shaped cross section and, as illustrated, may be fastened to the servicing flap 21 in such a way that swinging up the servicing flap causes a pivoting of the spray-bar mounting 30, so that a spray bar 40 inserted into the spray-bar mounting 30 can be pivoted into a servicing position.

As is likewise evident in this figure, the spray bar 40 has at its two longitudinal ends holding regions 41 which have an essentially rectangular cross section. In this case, two of the parallel sides of the rectangular cross section match with the orifice cross section of the spray-bar mounting 30 which in this embodiment has the U-shaped cross section described. When the spray bar 40 is inserted via its holding region 41 into the spray-bar mounting 30, in the embodiment illustrated it can be displaced in the direction of the legs of the spray-bar mounting 30. By contrast, it is fixed in the transverse direction to this.

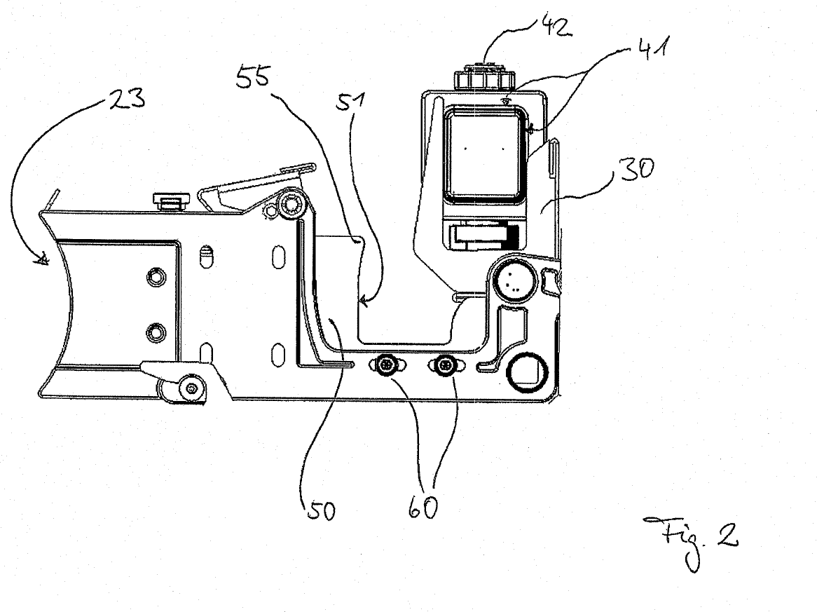

The other two parallel sides of the rectangular cross section match, in the embodiment illustrated, with a guide orifice 52 which is provided on a positioning element 50. In this case, in the embodiment illustrated, a positioning element 50 is mounted on each of the two longitudinal ends of the dampening-unit housing 20. As illustrated in FIG. 2, the guide orifice 52 has an abutment region 51 with which one side of the holding region 41 comes into abutting contact when the spray bar 40 is pivoted into the operating position. In this embodiment, the guide orifice 52 illustrated has the further wall region on the other opposite side. The distance between this wall region and the abutment region 51 may conform approximately to the width of the corresponding part of the holding region 41.

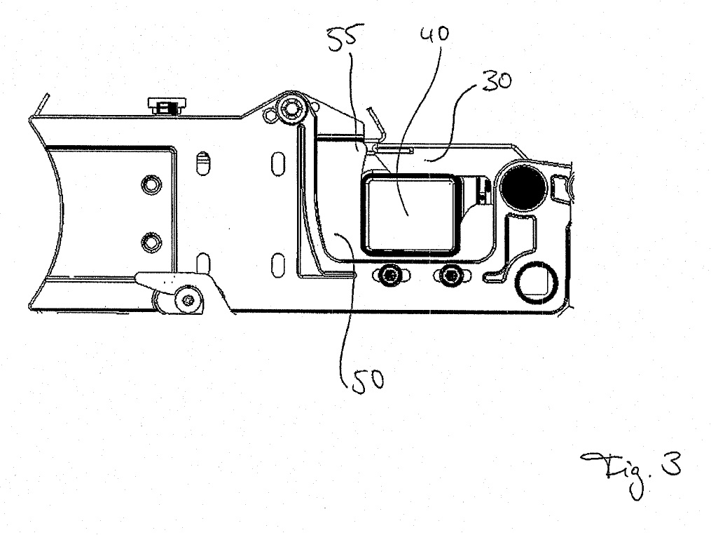

After the spray bar 40 has been pivoted into the operating position which is illustrated in FIG. 3, the holding regions 41 are therefore pivoted into the guide orifice 52, and although the spray bar 40 is not fixed in the spray-bar mounting 30 in the spraying direction of its spray nozzles 42, it is fixed to this position, even in the spraying direction, as a result of the co-operation of its holding region 41 with the guide orifice 52. The displaceability which the spray bar 40 still has in the spray-bar mounting 30 is therefore taken away from it when it is pivoted into the guide orifice 52.

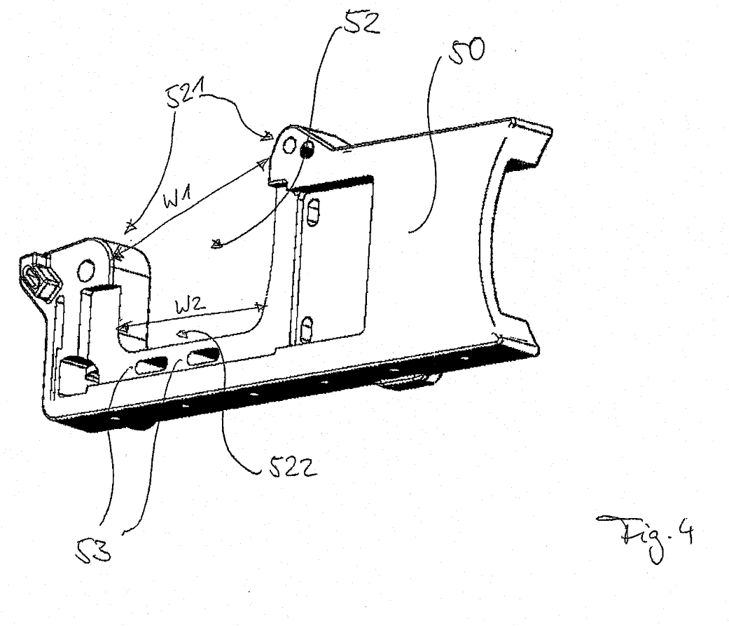

The exact position in the spraying direction in which the spray bar 40 is thereby fixed in its operating position can be set via a fine-setting device 60. In the embodiment illustrated, the fine-setting device 60 is implemented by long holes in a side part of the dampening-unit housing 20 and by matching screws by means of which the positioning element 50 is fixed in the dampening-unit housing 20. The long holes can additionally or alternatively also be provided on the positioning element 50 which in the embodiment illustrated is designed as a plate-shaped element and can be produced in one piece by the plastic injection-moulding method. The long holes in the positioning element 50 are illustrated in FIG. 4 and form a mounting region 53.

Furthermore, on the positioning element 50 illustrated, a locking region 55 is provided which causes a latching of the spray bar 40 in the positioning element 50. The locking region 55 is illustrated in FIGS. 2 and 3. In the positioning element 50 illustrated, that wall region of the positioning element which lies opposite the abutment region 51 is designed to be markedly shorter, so as to provide an orifice region 521 in the guide orifice 52 which has an orifice width W1 which is markedly greater than the width of the corresponding region of the holding region 41 of the spray bar 40. At the bottom of the guide orifice 52, a bottom region 522 is formed, which has a bottom width W2 which conforms essentially to the corresponding width of the holding region 41.

A set of positioning elements 50 which has differently configured positioning elements 50 may be provided for a dampening device 10 or for a dampening-unit housing 20. A different configuration of this type may, for example, be one where the abutment regions 51 of the respective positioning elements 50 are with respect to the spraying direction of a spray bar 40 inserted into the positioning plate at a different distance from the respective mounting region 53 of the respective positioning element 50.

A suitable positioning element 50 being selected, therefore, a distance between the abutment region 51 and a surface of a duct roller which is to be dampened by the dampening device 10 can be preselected. Exact positioning can then take place via the fine-setting device 60.

### LIST OF REFERENCE SYMBOLS

10 Dampening device

20 Dampening-unit housing

21 Servicing flap

22 Inspection flap

23 Spray space

30 Spray-bar mounting

40 Spray bar

41 Holding region

42 Spray nozzle

50 Positioning element

51 Abutment region

52 Guide orifice

521 Orifice region

W1 Orifice width

522 Bottom region

W2 Bottom width

53 Mounting region

55 Locking region

60 Fine-setting device

What is claimed is:

1. Dampening device of a spray-dampening unit, comprising:
a dampening-unit housing,
a spray-bar mounting and
a spray bar,
the spray bar being connected to the dampening-unit housing via the spray-bar mounting in such a way that:
the spray bar is pivotable between an operating position and a servicing position,
in the servicing position, the spray bar having in relation to the spray-bar mounting at least one degree of freedom which makes it possible for the spray bar to be removable from the spray-bar mounting, and
this at least one degree of freedom being taken away from the spray bar when the latter is being pivoted into the operating position.

2. Dampening device of a spray-dampening unit according to claim 1, wherein the spray bar, together with the spray-bar mounting, is pivotable between the operating position and the servicing position.

3. Dampening device of a spray-dampening unit according to claim 1, wherein the spray-bar mounting has two essentially U-shaped profiles, each with two legs, and in the servicing position, the spray bar is inserted into the U-shaped profiles and is held displaceably between the legs of the U-shaped profiles.

4. Dampening device of a spray-dampening unit according to claim 3, wherein the dampening-unit housing includes a servicing flat and the U-shaped profiles are arranged on the servicing flap in such a way that, when the servicing flap is opened, the U-shaped profiles, together with the spray bar, are pivoted out of the dampening-unit housing into the servicing position.

5. Dampening device of a spray-dampening unit according to claim 1, wherein in the operating position of the spray bar, the dampening-unit housing forms in front of the spray bar in the spraying direction an essentially closed-off spray space, the dampening-unit housing having in the region of the spray space an inspection flap, via which the spray space is accessible from outside the dampening-unit housing.

6. Dampening device of a spray-dampening unit according to claim 1, wherein during the pivoting of the spray bar into the operating position its at least one degree of freedom being taken away via the pivoting of a holding region of the spray-bar into a guide orifice of a positioning element.

7. Dampening device of a spray-dampening unit, comprising:
a dampening-unit housing,
a positioning element and
a spray bar,
the positioning element having a mounting region and an abutment region,
the positioning element being mounted exchangeably on the dampening-unit housing via the mounting region, and
the abutment region being configured in such a way that the spray bar is adapted to be brought to abut against the abutment region of the positioning element, so that a defined position of the spray bar in relation to the dampening-unit housing is adapted to be ensured via the abutment against the abutment region.

8. Dampening device of a spray-dampening unit according to claim 7, wherein the dampening device includes a fine-setting device, via which the exchangeable mounting of the positioning element on the dampening-unit housing is adapted to be brought about, and via which the position of the positioning element with respect to the dampening-unit housing is adapted to be finely set.

9. Dampening device of a spray-dampening unit according to claim 7, wherein the dampening device of a spray-dampening unit has a set of positioning elements in which the abutment regions are in different positions with respect to the mounting regions, so that a rough setting of the position of the spray bar in the dampening-unit housing is adapted to be carried out via the selection of at least one respective positioning element.

10. Dampening device of a spray-dampening unit according to claim 7, wherein the abutment region of the positioning element is provided in the region of a guide orifice of the positioning element into which the spray bar is adapted to be inserted into an operating position.

11. Dampening device of a spray-dampening unit according to claim 7, further comprising a spray-bar mounting, and wherein:
the spray bar being connected to the dampening-unit housing via the spray-bar mounting in such a way that:
the spray bar is pivotable between an operating position and a servicing position,
in the servicing position, the spray bar having in relation to the spray-bar mounting at least one degree of freedom which makes it possible for the spray bar to be removable from the spray-bar mounting, and
this at least one degree of freedom being taken away from the spray bar when the latter is being pivoted into the operating position,
the spray bar, together with the spray-bar mounting, is pivotable between the operating position and the servicing position,
the spray-bar mounting has two essentially U-shaped profiles, each with two legs, and in the servicing position, the spray bar is inserted into the U-shaped profiles and is held displaceably between the legs of the U-shaped profiles,
the dampening-unit housing includes a servicing flap and the U-shaped profiles are arranged on the servicing flap in such a way that, when the servicing flap is opened, the U-shaped profiles, together with the spray bar, are pivoted out of the dampening-unit housing into the servicing position, and
in the operating position of the spray bar, the dampening-unit housing forms in front of the spray bar in the spraying direction an essentially closed-off spray space, the dampening-unit housing having in the region of the spray space an inspection flap, via which the spray space is accessible from outside the dampening-unit housing.

12. Dampening device of a spray-dampening unit according to claim 10, wherein the guide orifice of the positioning element has:
an orifice region with an orifice width which is greater than a corresponding width of the spray bar, and
a bottom region with a bottom width which conforms to the corresponding width of the spray bar.

13. Dampening device of a spray-dampening unit according to claim 10, wherein the guide orifice of the positioning element has an elastically deformable locking region which, after complete insertion of the spray bar, fixes the spray bar in its operating position.

14. Method for positioning a spray bar in a dampening device of a spray-dampening unit, comprising the steps of:
providing a dampening-unit housing,
providing a set of positioning elements which each have a mounting region and an abutment region, the set having different positioning elements,
providing a spray bar,
selecting a positioning element suitable for a desired position of the spray bar in the dampening-unit housing from the set of positioning elements, and
mounting the selected positioning elements.

15. Method according to claim 14, wherein the dampening device of a spray-dampening unit includes a dampening-unit housing, a positioning element and a spray bar, the positioning element having a mounting region and an abutment region, the positioning element being mounted exchangeably on the dampening-unit housing via the mounting region, and the abutment region being configured in such a way that the spray bar is adapted to be brought to abut against the abutment region of the positioning element, so that a defined position of the spray bar in relation to the dampening-unit housing is adapted to be ensured via the abutment against the abutment region.
